(19) United States
(12) Patent Application Publication
(10) Pub. No.: US 2003/0108391 A1
(43) Pub. Date: Jun. 12, 2003

(54) Passive irrigation pipe installation reel stand

(76) Inventor: Lee Essay, Southampton, NY (US)

Correspondence Address: ALFRED M. WALKER, 225 OLD COUNTRY ROAD, MELVILLE, NY, 11747-2712, US

(21) Appl. No.: 10/314,930

(22) Filed: Dec. 9, 2002

Related U.S. Application Data
(60) Provisional application No. 60/339,854, filed on Dec. 12, 2001.

(51) Int. Cl. F16L 1/00; B63B 35/03

(52) U.S. Cl. 405/154.1; 405/174; 405/177; 242/615.2

(57) ABSTRACT

A passive installation reel stand automatically dispenses a flexible conduit pipe, such as irrigation pipe for underground sprinkler systems, in a desired position within a trench dug in the ground by a vibratory plow. The power of the forward advancing vibratory plow machine pulls the flexible conduit pipe from its spiral coil configuration upon a reel mounted upon the stand. The stand includes a wheel barrow-type carriage having one or more wheels, at a front end, and a kickstand at a liftable rear end with at least one handle. The reel is passively rotated by the flexible conduit pipe being pulled by a connection, such as a chain linkage, linked to the forward moving vibratory plow digging a trench for installation of the flexible conduit pipe therethrough. The coiled, flexible conduit pipe is mounted on the reel, fed through a guide opening, picked off the reel, and attached in the trench dug by the advancing vibratory plow.

### FIELD OF THE INVENTION

The present invention relates to laying of flexible pipes within the ground, especially for underground lawn sprinkler systems, plumbing hoses, electric lines or agricultural irrigation.

### BACKGROUND OF THE INVENTION

Underground conduits, such as flexible irrigation pipes for underground lawn sprinkler systems, are generally installed with motorized vibratory plow machines, which plow a thin trench for installation of a conduit therein. These vibratory plow machines need to be operated by a skilled laborer, as the plow blades dig a linear trench for insertion of the flexible underground conduits therein.

Typically, these flexible irrigation pipes are plastic, such as polyethylene, with diameters of about one inch, one and a quarter inches, or one and a half inches. They are stored in a continuous spiral coil, which is gradually unraveled during installation of the pipe within a trench in the ground formed by the vibratory plow.

The vibratory plow is used to facilitate rapid deployment of the flexible pipe or other conduit within the trench in the ground.

The flexible conduit spiral coils are usually supplied on a reel, which is hand carried or mounted on top of an advancing vibratory plow machine. The pipe is advanced within the trench as it is pulled by a connection to the vibratory plow, which has a shaking vibrator which vibrates the plow blade to enable it to dig the trench in the ground and pull the flexible conduit therethrough, as noted in U.S. Pat. No. 3,357,498 of Higley, U.S. Pat. No. 3,618,237 of Davis, U.S. Pat. No. 4,079,593 of Flippin and U.S. Pat. No. 6,186,242 of Bricko.

Typically, the user assembles the flexible pipe into the trench as the vibratory plow pulls the flexible conduit from the reel down into the trench in the desired location. Only then is the trench ready for filling with soil or other material.

The labor intensive problem with using vibratory plows for installing flexible lawn sprinkler conduits is that the flexible irrigation pipes are pulled by the plow blade of a vibratory plow from the spiral coils which are hand carried by a second laborer, in addition to the laborer operating the vibratory plow machine.

To accurately release the flexible conduit pipe manually is a tedious job because proper alignment of the flexible conduit pipe must be made as the pipe is laid within the trench, by applying appropriate directional unreeling of the pipe during installation, which must be done carefully.

Among prior art attempts to minimize manpower during flexible pipe installation include those which attach a reel on top of a vibratory plow machine, such as in U.S. Pat. No. 5,039,252 of Schuermann for a pivotally mounted hose reel feed permanently mounted to a vibratory plow, as well as U.S. Pat. No. 6,234,718 of Moffitt, which includes a reel mounted to a trailer pulling a vibratory plow. However, these vibratory plow machines are complicated, and bear the weight of the reel spinning mechanism as extra weight adding to its cost.

Furthermore, U.S. Pat. No. 4,346,843 of Long describes an irrigation hose reel which is mounted on a wagon pulled during passing of water under pressure through the hose. However, Long '843 does not describe use of a reel with a vibratory plow machine.

Consequently, the prior art irrigation pipe systems either require the use of an extra laborer or the use of a complicated cable-feed mechanism mounted to the top of a vibratory plow machine.

Therefore, there is a need for a low cost, passive irrigation reel stand for installing flexible pipe with a vibratory plow without the need for extra manpower or complex machinery and added weight to the vibratory plow.

### OBJECTS OF THE INVENTION

It is therefore an object of the present invention to provide a passive reel stand for rapidly dispensing tightly wound coils of flexible conduit pipes or other tubular objects, into a trench dug by an advancing vibratory plow.

It is also an object of the present invention to provide a passive reel stand which dispenses flexible conduit pipes therefrom and properly aligns the flexible conduit pipes into an aligned position within a trench dug in the ground by the vibratory plow.

It is yet another object of the present invention to provide a passive reel stand which applies an accurate amount of flexible conduit pipe within a trench dug by an advancing vibratory plow.

It is yet another object of the present invention to improve over the disadvantages of the prior art.

### SUMMARY OF THE INVENTION

In keeping with these objects and others which may become apparent, the present invention includes a passive installation reel stand used to automatically dispense a flexible conduit pipe, such as irrigation pipe for underground sprinkler systems, in a desired position within a trench dug in the ground by a vibratory plow. The power of the forward advancing vibratory plow machine pulls the flexible conduit pipe from its spiral coil configuration upon a reel mounted upon the stand.

The vibratory plow machine includes the plow blade, located and operable in the longitudinal axis of the trench to be dug. The blade is mounted ahead of the vibrator, which has a forward propelling motor and wheels for movement forward on the ground in the direction of the trench for the flexible pipe. The trailing end of the plow blade lays the flexible conduit behind it as it travels forward, creating the trench, which is normally very thin, such as one and one half inch or less in width, to accommodate the flexible conduit therein. Since the opening of the trench, typically from eight inches to twelve inches below the ground, is only about an inch or an inch and a half in width, it can be covered by tampering plowed out soil down with a tool, such as a hoe or rod with a tampering head.

The stand includes a wheel barrow-type carriage having one or more wheels, such as a pair of wheels, at a front end, and a kickstand at a liftable rear end with at least one handle.

The passive pipe installation stand is preferably manufactured from strong materials, such as solid steel members, or comparable alloys or synthetic composites, and supports the rotatable reel supporting the spiral coil of flexible conduit pipe thereon.

The reel is passively rotated by the flexible conduit pipe being pulled by a connection, such as a chain linkage, linked to a forward moving vibratory plow digging a trench for installation of the flexible conduit pipe therethrough. The connector is attached to the blade of the vibratory plow.

The coiled, flexible conduit pipe is mounted on the reel, fed through a guide opening, picked off the reel, and attached in the trench dug by the advancing vibratory plow.

The reel for the vibratory plow assembly of the present invention is designed to stand still behind the vibratory plow until a desired length of the pipe is laid within the trench dug by the vibratory plow.

In order to stabilize the reel in place in a stationary position suitable for dispensing of the flexible pipe from the reel upon the stand, the mounting stand for the reel includes a kickstand which includes a user operable anchor spike insertable within the ground.

In a preferable embodiment, the flexible irrigation pipe installation reel stand includes a horizontal rectangular frame with a pair of side members, a front member joining front ends of the side members, and a rear member joining rear ends of the side members. A pair of wheels is mounted on opposite ends of the front member to permit the frame to be moved. The stand also has a pair of arms extending rearwardly from opposite ends of the rear member for permitting hands-on movement of the frame.

A first generally vertical member extends up from one of the side members between the front and rear ends of each side member.

By being a generally vertical member, the term “vertical” therein is meant to be a member extending generally in a vertical direction. Therefore, an upwardly extending member having an oblique portion adjacent to a vertical portion is considered to be within the scope of the invention.

This flexible irrigation pipe installation stand has a second generally vertical member extending up from a side member opposite the side member supporting said first vertical member with an axle extending between the vertical members, wherein the mounted reel rotates on the axle.

The rotatable reel is mounted on the first vertical member, and the flexible irrigation pipe is wound on the reel.

The reel has radially extending arms at opposite ends of the axle and horizontal arms joining free ends of the radially extending arms for supporting the flexible irrigation pipe. Preferably, the axle has a joint separating the axle into two separate axle segments, to permit one of the vertical members to be pivoted out of the way, to facilitate installation of the flexible irrigation pipe on the reel.

To guide the flexible pipe in a trench in the ground, a hollow alignment guide is mounted on the front member. The flexible irrigation pipe is fed through the hollow alignment guide to guide the flexible tube, as the flexible irrigation pipe is dispensed from the reel.

To control the reel stand in place, a downwardly extending stake or spike extends from the rear member into the ground. To allow said stand to be fixed in place when the flexible irrigation pipe is to be dispensed, the stake or spike is lifted out of the ground by raising it, to permit the stand to be repositioned in another location.

The reel stand for burying the flexible tube preferably is used behind the propelled vibratory plow having a blade for digging a trench in the ground. The reel stand is stationary and supports a roll of the flexible tube to dispense the flexible tube. The free end of the flexible tube extends from the reel connected to the vibratory plow blades with the blade burying the flexible tube in the trench as the vibratory plow is propelled forward. This stationary installation reel stand is mounted on a pair of wheels for positioning in relation to the propelled vibratory plow and has the downwardly extending vertical stake or spike to fix the reel stand in place, once the reel stand is positioned.

In operation, the stationary reel stand helps to bury the flexible tube in a trench in the ground.

A free end of the flexible tube extending from the reel stand is connected to the blade, so that the blade buries the flexible tube in the trench as the vibratory plow is propelled forward. The stationary installation reel stand is fixed in place by pushing the downwardly extending vertical stake or spike into the ground. The wheels of the reel stand position the reel stand in relation to the propelled vibratory plow, which moves forward while the reel stand is fixed by the downwardly extending vertical stake or spike.

The assembly of the reel upon the positive installation stand can preferably lay underground sprinkler pipes, however it will be understood the reel may also dispense other flexible conduit, such as electrical cables, plumbing hoses, or agricultural irrigation pipes dispensed from a coil, upon the reel. The flexible conduit is pulled from the reel mounted on the stationary mounting stand, and through the trench while attached to the trailing edge of the blade of the vibratory plow blade. The advanced flexible conduit pipe is placed in the thin trench in the ground from the passively rotating reel, which sits upon the mounting stand while the vibratory plow moves forward.

The flexible conduit pipe is attached to the blade by a yoke which is attached to the vibratory plow.

Other advantages and of the passive irrigation pipe installation reel stand of this invention will be more fully understood from the following description of the preferred embodiments, the appended Claims and the drawings, a brief description of which follows.

### BRIEF DESCRIPTION OF THE DRAWINGS

The present invention can best be understood in conjunction with the accompanying drawings, in which:

FIG. 1 is a diagrammatic elevational view of prior art;

FIG. 2 is a perspective view of the present invention;

FIG. 3 is a perspective view of another embodiment—with tubing removed for clarity;

FIG. 4 is a front elevational view shown with hose tubing;

FIG. 5 is a front elevational view taken in the direction of arrow 5 of FIG. 3 with tubing;

FIG. 6 is a right side elevational view taken in direction of arrow 6 of FIG. 5;

FIG. 7 is a left side elevational view taken in direction of arrow 7 of FIG. 5;

FIG. 8 is a perspective, exploded view of an alternate embodiment, illustrating construction and ease of assembly;

FIG. 9 is an enlarged perspective view taken from arrow 9 of FIG. 2, illustrating vertical movement of the anchoring spike;

FIG. 10 is an enlarged elevational view of the spike;

FIG. 11 is a partial side elevational view of the strut having accessory supports;

FIG. 12 is a partial front elevational view of the strut having accessory supports taken along arrows 12-12 of FIG. 11; and,

FIG. 13 is a partial side elevational view of the accessory reel guide.

### DETAILED DESCRIPTION OF THE INVENTION

A prior art vibratory plow blade 1 of a prior art vibratory plow 2 shown in FIG. 1 is advanced by wheels 3 moved by a self propelled motor; or is pulled behind a tractor (not shown) or other utility vehicle. The prior art vibrator 5 vibrates plow blade 1 for digging a trench in the direction of the arrows shown. Prior art connector 6, such as a chain linkage, pulls a section of a prior art flexible conduit 7, such as an underground sprinkler pipe, an electrical cable or an agricultural irrigation pipe, behind plow blade 1. The trench thus formed extends longitudinally in the desired axis for laying flexible conduit 7, and is typically about ten inches deep and one and one half inches in width.

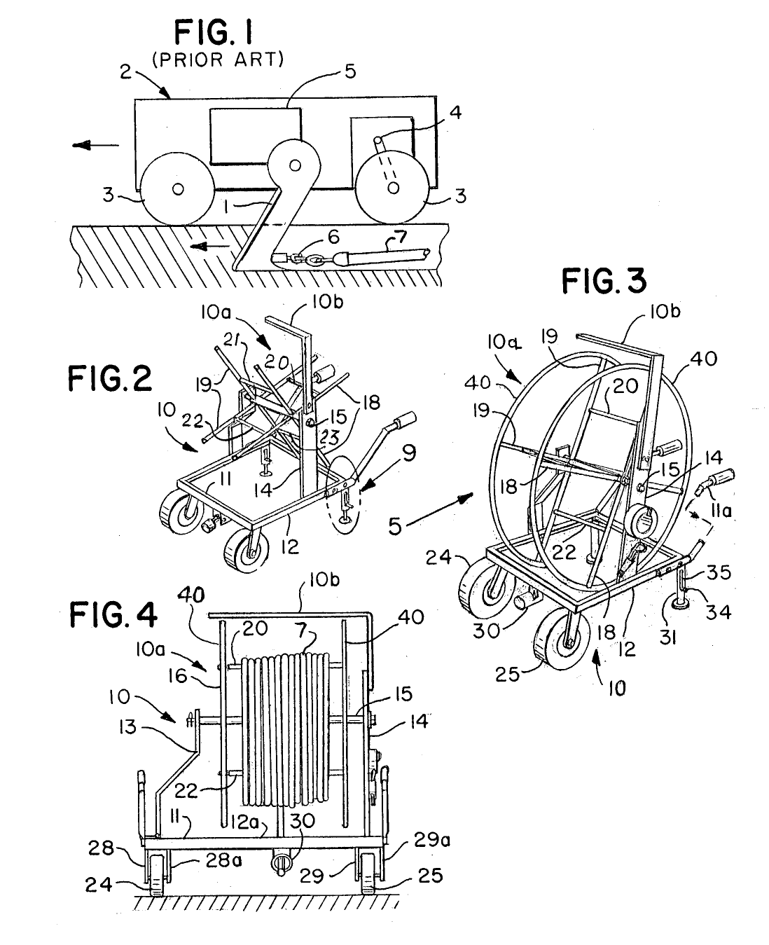

FIGS. 2-13 show embodiments for the passive irrigation pipe installation reel stand 10 of the present invention. Stand 10 includes carriage 11 of horizontal supports 12 supporting vertical struts 13, 14, extending upward therefrom. Front and rear horizontal supports 12a connect horizontal supports 12 together, forming a rectangular configuration of carriage 11.

Vertical struts 13, 14 support axle 15 in a rotatable position extending therethrough.

In a preferred embodiment, carriage 11 is about twenty eight inches long and about twenty six inches wide, to accommodate a typical spiral coil of flexible pipe 7 upon a reel 10a supported by carriage 11.

Axle 15 extends transversely across carriage 11 of stand 10, and supports reel 10a having circular structural members 40 connecting radially extending right reel arms 18 and left reel arms 19 extending therefrom. Each set 18, 18 and 19, 19 of the left and right radially extending arms are preferably perpendicular to each other, with one half of each respective pair of arms 18, 18 and 19, 19 extending outward from axle 15 in opposite directions, forming right angles therebetween. Arms 18, 18 and 19, 19 meet at their common left and right side vortexes at axle 15. Near or at the opposite, distal ends of each right side radially extending arm, are roll holder cross brackets 20, 21, 22, 23 connecting arms extending cantilevered out therefrom toward opposite left side radially extending arms 19, 19.

Top bar 10b extends upward from right side vertical strut 14, and extends then horizontally over reel 10a to stop unnecessary upward shifting of the coil spiral of flexible conduit pipe 7 upon reel 10a. As shown in FIGS. 3, 4, and 11 right side vertical strut 14 also optionally has holders 14a, 14b for accessories, such as a tube cutter 14c or adhesive tape 14d.

In order to install the coil of flexible pipe conduit 7 upon reel 10a of reel stand 10, axle 15 is removably joined to non-pivotable vertical strut 14 or else is removably joined to non-movable vertical strut 14, so that left side radially extending arms 19, 19 can separate from reel 10a, giving clearance for installing a spiral coil of flexible conduit pipe 7 upon reel 10a.

Therefore, axle 15 is connected to the pairs of radially extending arms 19, 19 or 20, 20, so that left pair of radially extending arms 19, 19 can be removed out of the way, along with swing out vertical strut 13, to install the coil spiral of flexible conduit pipe 7 upon roll holder cross brackets 20, 21, 22, 23, so that coil spiral of flexible conduit pipe 7 can revolve about axle 15 of reel 10a of reel stand 10. When joined, left side arms 19, 19 are fastened to roll holder brackets 20, 21, 22, 23 by fasteners.

Coil spirals of flexible conduit pipes 7 can be easily installed over transverse cross brackets 20, 21, 22 and 23 of radially extending arms 19, 19 and 20, 20. Left side swing out vertical strut 13 pivots outward from carriage 11 of reel stand 10, in a direction perpendicular to the longitudinal axis of carriage 11 of reel stand 10 to allow for installation of a coil spiral of flexible conduit pipe 7 upon reel 10a.

Axle 15 may be removably joined at the center by an axle joint separating axle 15 into two axle portions. Each axle portion of axle 15 is respectively connected to the pair of left side radially extending arms 19, 19 or right side radially extending arms 20, 20, so that one of the pairs 19, 19 can be removed out of the way, along with pivotable swing out vertical strut 13, to install the coil spiral of flexible conduit pipe 7 upon roll holder cross brackets 20, 21, 22, 23. In that manner, the coil spiral of flexible conduit pipe 7 can revolve about axle 15 of reel 10a of reel stand 10.

After the coil spiral of flexible pipe 7 is installed over cantilevered roll holder brackets 20, 21, 22, 23, these roll holder brackets 20, 21, 22, 23 are connected by fasteners, such as bolts, to the left side radially extending arms 19, 19 joining them to parallel extending, right side radially extending arms 20, 20.

Reel stand 10 includes front wheels 24, 25 which rotate about axles 26, 27 extending between respective downward struts 28, 28a and 29, 29a extending down from carriage 11 of reel stand 10.

Also extending down from front horizontal support 12a by bracket bar 30a in a slanted oblique direction from carriage 11, is hollow alignment guide 30, preferably annular or cylindrical, through which flexible conduit pipe 7 is guided, as shown in FIG. 13, for proper installation within a trench dug by vibratory plow blade 1 shown in FIG. 1. Typically, alignment guide 30 is about three inches long and 2 and one half inches in inner guide diameter, to provide a loose, but guided fit for the flexible conduit pipe 7, which has preferably an outer diameter of usually between one and one and one half inches in diameter. Because of the size of the diameter of the opening of alignment guide 30, the flexible conduit pipe 7 has enough side clearance to prevent snagging, but is limited in diameter to point the flexible conduit pipe 7 in the direction of the trench being dug by the vibratory plow blade pulling and advancing the flexible conduit pipe from the reel into the trench in the ground.

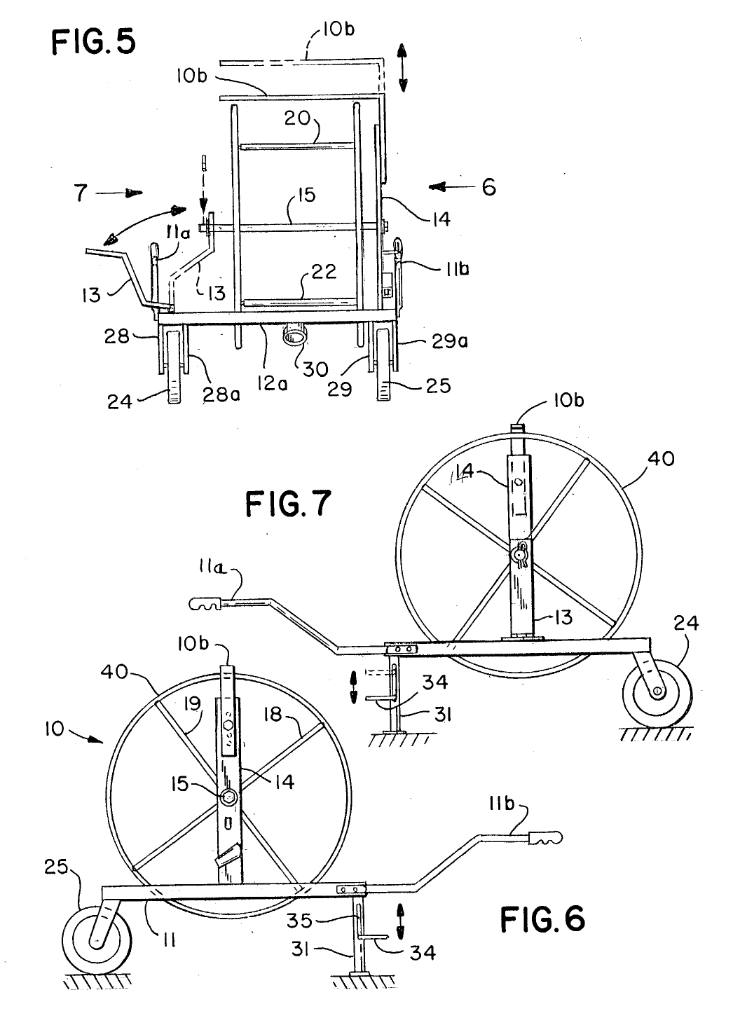

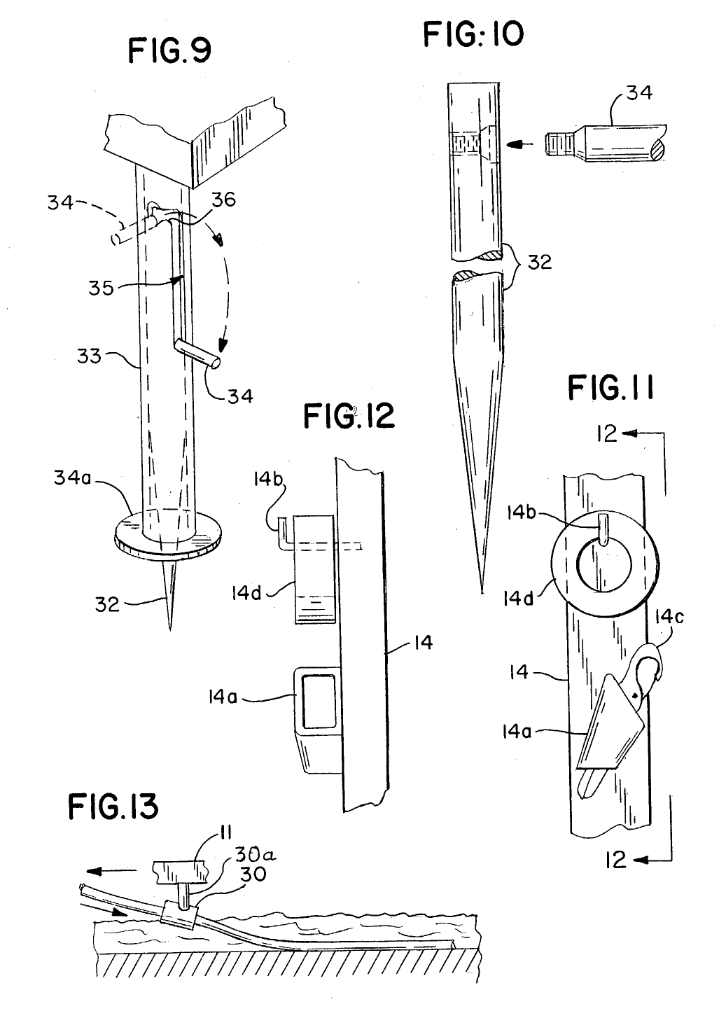

As shown in FIGS. 5, 6 and 7, wheels 24, 25 and handles 11a, 11b of carriage 11 are used to manually push or pull the passive reel stand into place at the beginning of the location for a trench to be dug. When the appropriate location of the reel stand 10 is determined, the reel stand 10 is anchored in place by anchor 31, as shown in FIGS. 9 and 10, which includes anchor spike 32 movable within hollow sleeve 33 by anchor handle 34. Slot 35 is provided for movement of anchor handle 34 as spike 32 is moved within hollow sleeve 33. When withdrawn upward, anchor handle 34 of spike 32 is rotated ninety degrees to shoulder 36 of sleeve 33.

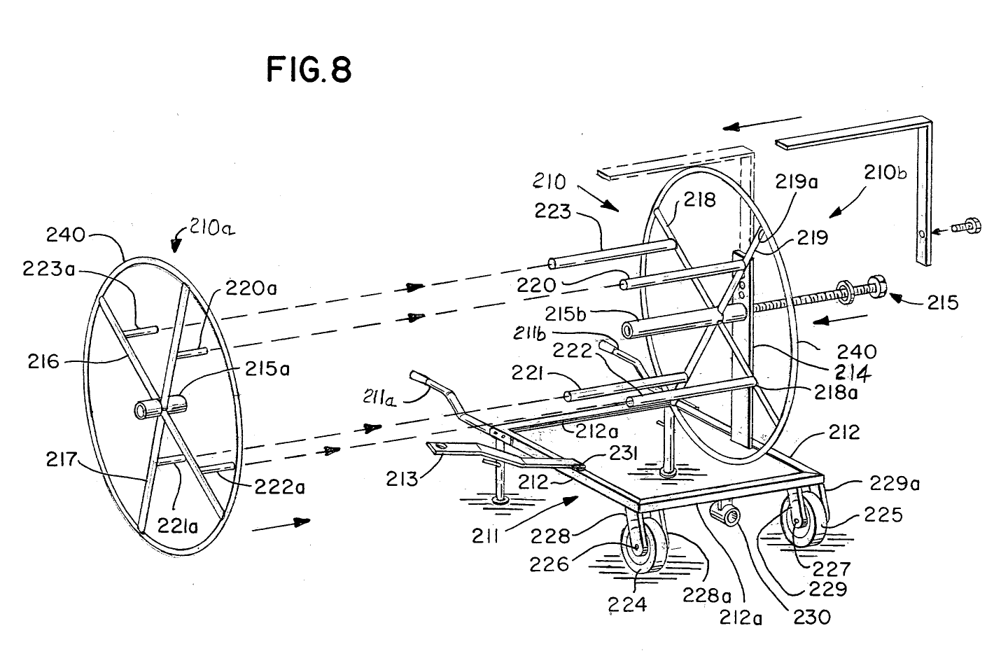

FIG. 8 shows an alternate embodiment with circumferentially extending stops 240 to prevent lateral movement of a coil of flexible pipe (not shown, but similar to spiral coil 7 shown in FIGS. 2-7 herein) upon reel stand 210.

For example, FIG. 8 shows the passive irrigation pipe installation reel stand 210 of the present invention. Stand 210 includes carriage 211 of horizontal supports 212 supporting vertical struts 213, 214, extending upward therefrom. Front and rear horizontal supports 212a connect horizontal supports 212 together, forming a rectangular configuration of carriage 211. Right side vertical strut 214 supports axle 215 in a fixed position extending cantilevered therefrom.

Axle 215 extends transversely across carriage 211 of stand 210. Axle 215 is attached to right side non-movable vertical strut 214 and is insertable within respective left side sleeve 215a and right side sleeve 215b, which are respectively attached to left side radially extending arms 216, 217 and right side radially extending arms 218, 219. Pulling of the flexible conduit hose 7 (not shown in FIG. 8) results in rotation of sleeves 215a and 215b of left reel side 210a and right reel side 210b about fixed axle 215.

Each set 216, 217 and 218, 219 of the left and right radially extending arms are preferably perpendicular to each other, with one half of each respective pair of arms 216, 217 and 218, 219 extending outward from axle 215 in opposite directions, forming right angles therebetween. Arms 216, 217 and 218, 219 meet at their common left and right side vortexes at axle 215.

To support the spiral coil of flexible conduit hose 7 (not shown) upon left and right reel sides 210a, 210b, near or at the opposite, distal ends 218a, 219a of each right side radially extending arm 218, 219 are roll holder cross brackets 220, 221, 222, 223 connecting arms extending cantilevered out therefrom toward opposite left side radially extending arms 216, 217.

Roll holder cross brackets 220, 221, 222, 223 are preferably hollow, accepting corresponding rods or pins 220a, 221a, 222a and 222a attached to respective left side radially extending arms 216, 217, thus forming the reel of left reel side 210a and right reel side 210b.

For installation of a new spiral coil of flexible conduit hose 7 (not shown) upon the reel formed by left reel side 210a and right reel side 210b, rods or pins 220a, 221a, 222a and 222a are removed from hollow roll holder cross brackets 220, 221, 222 and 222, when left side axle sleeve 215a is removed from over axle 215, thereby separating left and right reel sides 210a and 210b.

As shown in FIGS. 11 and 12, right side vertical strut 214 of FIG. 8 can also optionally have holders 14a, 14b for accessories, such as a tube cutter holder 14a for tube cutter 14c or adhesive tape holder rod 14b for adhesive tape roll 14d, such as shown in FIG. 11 herein.

Left side swing out vertical strut 213 pivots outward from carriage 211 of reel stand 210, in a direction perpendicular to the longitudinal axis of carriage 211 of reel stand 210 to allow for installation of a coil spiral of flexible conduit pipe 7 (not shown) upon the reel formed by left reel side 210a joined to right reel side 210b.

Reel stand 210 includes front wheels 224, 225 which rotate about axles 226, 227 extending between respective downward struts 228, 228a and 229, 229a extending down from carriage 211 of reel stand 210.

Also extending down from front horizontal support 212a in a slanted oblique direction from carriage 211, is hollow alignment guide 230, preferably cylindrical, through which flexible coil pipe 7 (not shown) is guided for proper installation within a trench dug by vibratory plow blade 1 shown in FIG. 1.

The wheels 224, 225 and handles 211a, 211b of carriage 211 are used to manually push or pull the passive reel stand into place at the beginning of the location for a trench to be dug. When the appropriate location of the reel stand 210 is determined, the reel stand 210 is anchored in place by anchor 231, similar to anchor 31 herein.

It is further known that other modifications may be made to the present invention, without departing from the scope of the invention.

I claim:

1. A flexible irrigation pipe installation reel stand comprising:
a horizontal rectangular frame comprising a pair of side members, a front member joining front ends of said side members, and a rear member joining rear ends of said side members;
a pair of wheels mounted on opposite ends of said front member to permit said frame to be moved;
a pair of arms extending rearwardly from opposite ends of said rear member for permitting hands on movement of said frame;
a first vertical member extending up from one of said side members between the front and rear ends of said one side member;
a rotatable reel mounted on said first vertical member, said flexible irrigation pipe being wound on said reel;
a hollow alignment guide mounted on said front member through which said flexible irrigation pipe is fed for guiding said flexible tube as said flexible irrigation pipe is dispensed from said reel; and
a downwardly extending stake extending from said rear member into the ground to allow said stand to be fixed in place when flexible irrigation pipe is to be dispensed from said reel, said stake being lifted out of the ground by raising said arms to permit said stand to be repositioned.

2. The flexible irrigation pipe installation stand of claim 1 having a second vertical member extending up from a side member opposite the side member supporting said first vertical member, with an axle extending between said vertical members, said reel mounted for rotation on said axle.

3. The flexible irrigation pipe installation stand of claim 2 in which said reel comprises radially extending arms at opposite ends of said axle and horizontal arms joining free ends of said radially extending arms for supporting said flexible irrigation pipe.

4. The flexible irrigation pipe installation stand of claim 2 in which said axle has a joint separating said axle into two separate axle segments to permit one of said vertical members to be pivoted out of the way to facilitate installation of flexible irrigation pipe on said reel.

5. An apparatus for burying a flexible tube comprising:
a propelled vibratory plow having a blade for digging a trench in the ground;
a stationary installation reel stand supporting a roll of said flexible tube for dispensing said flexible tube;
a free end of said flexible tube extending from said reel connected to said blade, said blade burying said flexible tube in said trench as said vibratory plow is propelled; and
said stationary installation reel stand mounted on a pair of wheels for positioning in relation to said propelled vibratory plow and having a downwardly extending vertical stake for fixing said reel stand in place once said reel stand is positioned.

6. The apparatus of claim 5 in which said reel stand includes a frame for supporting a rotating reel on which said flexible tube is rolled and a hollow alignment guide mounted on said frame through which said flexible tube is guided for proper installation within said trench.

7. The apparatus of claim 6 in which said frame is made of members forming a rectangle in a horizontal plane, said wheels mounted on opposite sides of a front member of said frame facing said vibratory plow, a pair of arms extending from a rear of said frame for moving said reel stand, and said vertical stake being mounted on a rear member of said frame so that said stand can be moved when the rear of said frame is raised and said stake is above the ground and lowering the rear of said frame to drive said stake in the ground to fix said stand in place to permit unrolling of said flexible tube.

8. The method of burying a flexible tube in a trench comprising the steps of:
propelling a vibratory plow having a blade for digging a trench along a prescribed path;
placing behind said plow an installation reel stand supporting a roll of said flexible tube for dispensing said flexible tube;
connecting a free end of said flexible tube extending from said reel stand to said blade, said blade burying said flexible tube in said trench as said vibratory plow is propelled;
fixing said stationary installation reel stand in place by pushing a downwardly extending vertical stake into ground, said reel stand having a pair of wheels for positioning said reel stand in relation to said propelled vibratory plow and having said downwardly extending vertical stake for fixing said reel stand in place once said reel stand is positioned; and
raising said stake out of the ground to reposition said reel stand.
